(19) United States
(12) Patent Application Publication
(10) Pub. No.: US 2016/0319878 A1
(43) Pub. Date: Nov. 3, 2016

(54) SHAFT-HUB ASSEMBLY

(71) Applicant: Caterpillar Global Mining LLC, South Milwaukee, WI (US)

(72) Inventor: Carl D. Gilmore, South Milwakee, WI (US)

(73) Assignee: Caterpillar Global Mining LLC, South Milwaukee, WI (US)

(21) Appl. No.: 15/204,758

(22) Filed: Jul. 7, 2016

(51) Int. Cl. F16D 1/08

(52) U.S. Cl. CPC F16D 1/0876; B66D 1/14

(57) ABSTRACT

A shaft-hub assembly of a torque transmitting mechanism is provided. The shaft-hub assembly includes a shaft, a hub, and a key. The key couples the shaft to the hub. A first end of the shaft includes a first surface, which includes a first slot perpendicular to a central axis. The hub includes a disc attached to a hollow cylindrical member defining an axial passage. The disc includes a second slot perpendicular to the central axis and a plurality of first holes in communication with the second slot. The key fits within the first slot of the shaft and the second slot of the hub. The key includes a plurality of second holes axially aligned to the plurality of first holes in order to secure the key with the hub via a plurality of fasteners.

### TECHNICAL FIELD

The present disclosure relates to a shaft-hub assembly. More particularly, the present disclosure relates to the shaft-hub assembly for a torque transmitting mechanism.

### BACKGROUND

Lifting mechanism of a machine includes hoist cables attached to a load-lifting tool. The hoist cables are connected to a gearbox that is coupled to a motor through a torque-transmitting mechanism. The motor generates a torque required for the movement of the hoist cables. The torque-transmitting mechanism transfers the generated torque to the hoist gearbox. The torque transmitting mechanism includes a shaft coupled to a hub. In order to transmit the torque to the hoist gearbox, the shaft transfers the torque generated by the motor to the hub and the hub transfers the torque to the hoist gearbox. The primary means of torque transmission from the shaft to the hub is by an interference fit between an outer diameter of the shaft and an inner diameter of the hub. The interference fit between the shaft and the hub results in a frictional transmission of torque without rotational slippage of the hub on the shaft However, in sonic cases, such as an insufficient interference fit or torsional overload, rotational slippage between the hub and the shaft occurs. To prevent the rotational slippage, an axial key is fitted between the shaft and the hub. The shaft includes a key-seat that aligns along an axis of the shaft. The hub includes a keyway that extends along the axis of the shaft. In an assembled position of the hub and the shaft, the key-seat and the keyway combine to accommodate the key. The key couples the shaft to the hub to transmit the torque from the hub to the shaft and from the shaft to the hub, and to prevent rotational slippage or relative motion between the shaft and the hub.

The key-seat may create surface irregularities in the shaft. The surface irregularities may further lead to stress concentration in the shaft. During operation under torsional loading, the shaft may encounter high stress concentration in a specific portion thereof. High stress concentration in the specific portion may reduce strength of the shaft.

Patent Publication Number CN103133545 discloses a keyless shaft-hub connection device. The shaft-hub connection device includes a hub and an inner sleeve. Weldment of the hub to the inner sleeve defines an annular cavity. Deformation of the inner sleeve occurs during pressure fit of a shaft into the hub that locks the shaft within the annular cavity of the hub.

However, manufacturing process of the key-less shaft-hub assembly is complex and expensive. Hence, there is a need for an improved shaft-hub assembly.

### SUMMARY OF THE DISCLOSURE

Various aspects of the present disclosure describe a shaft-hub assembly. The shaft-hub assembly includes a shaft, a hub, and a key. The shaft includes a first end and a second end. The first end and the second end are defined along a central axis. The first end includes a first surface. The first surface includes a first slot provided perpendicular to the central axis. The hub includes a disc and a hollow cylindrical member. The disc attaches to the hollow cylindrical member to define an axial passage along the central axis. The axial passage accommodates the shaft. The disc includes a second slot perpendicular to the central axis. The disc includes a plurality of first holes in communication with the second slot. The key fits within the first slot of the shaft and the second slot of the hub. The key includes a plurality of second holes axially aligned with the plurality of first holes. A plurality of fasteners secures the key to the hub.

### BRIEF DESCRIPTION OF THE DRAWINGS

FIG. 1 is a perspective view of an exemplary torque transmitting mechanism including a shaft-hub assembly, in accordance with the concepts of the present disclosure;

FIG. 2 is a perspective view of a shaft of the shaft-hub assembly of FIG. 1, in accordance with the concepts of the present disclosure;

FIG. 3 is a perspective view of a hub of the shaft-hub assembly of FIG. 1, in accordance with the concepts of the present disclosure;

FIG. 4 is an exploded view of the shaft-hub assembly of FIG. 1 showing the hub, the shaft, a key, and fasteners, in accordance with the concepts of the present disclosure; and

FIG. 5 is a perspective view of the shaft-hub assembly of FIG. 1, in accordance with the concepts of the present disclosure.

### DETAILED DESCRIPTION

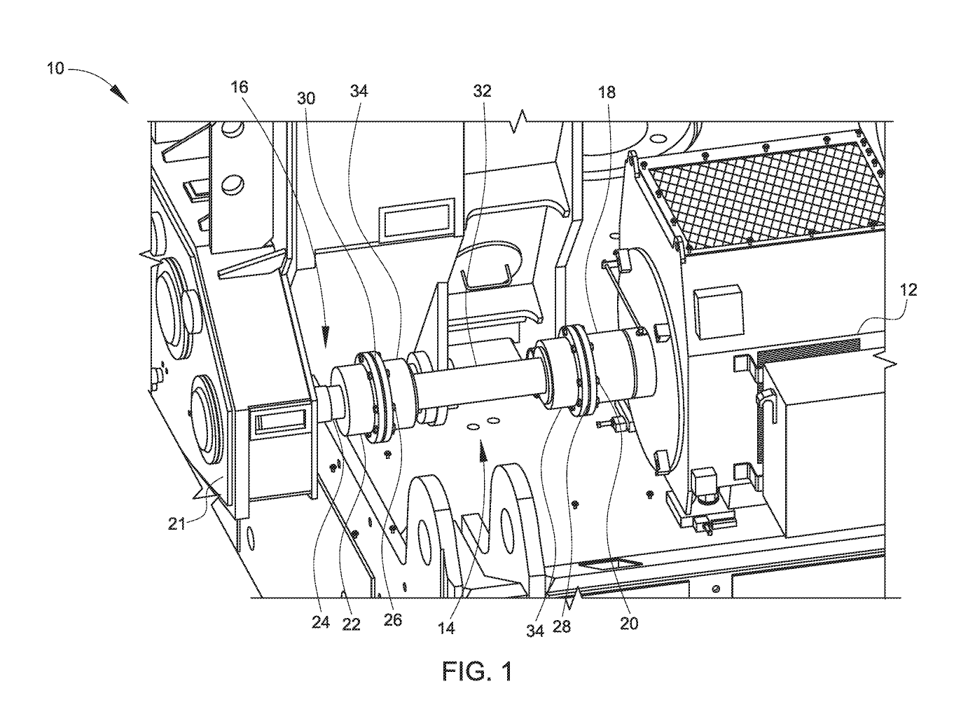

FIG. 1 shows an exemplary torque transmitting mechanism 10 that incorporates the concepts of the present disclosure. The torque transmitting mechanism 10 includes a motor 12, a shaft-hub assembly 14, and a hoist gearbox assembly 16. The motor 12 is coupled to a motor-coupling member 18 via an output shaft (not shown). The motor-coupling member 18 attaches to the shaft-hub assembly 14 via a number of first fasteners 20. The motor 12 operates to generate torque. The motor-coupling member 18 transfers the generated torque to the shaft-hub assembly 14.

The hoist gearbox assembly 16 includes a hoist gearbox 21, a gearbox-coupling member 22, and an input shaft 24. The input shaft 24 couples the hoist gearbox 21 and the gearbox-coupling member 22. The gearbox-coupling member 22 attaches to the shaft-hub assembly 14 via a number of second fasteners 26.

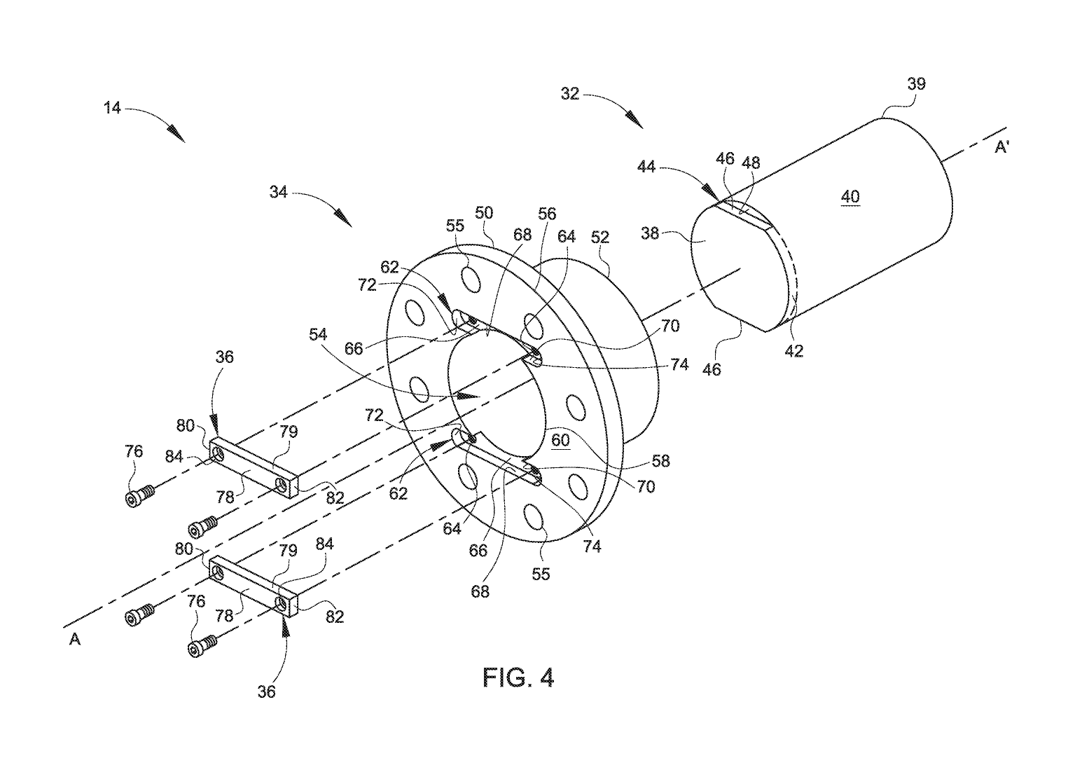

The shaft-hub assembly 14 includes a motor-facing end 28 and a gearbox-facing end 30. The shaft hub assembly 14 includes a shaft 32, a hub 34, and a key 36 (refer to FIG. 4) on both the motor-facing end 28 and the gearbox-facing end 30. The key 36 (refer to FIG. 4) interlocks the hub 34 and the shaft 32 on the motor-facing end 28. Similarly, the key 36 (refer to FIG. 4) interlocks the hub 34 and the shaft 32 on the gearbox-facing end 30. At the motor-facing end 28, the hub 34 attaches to motor-coupling member 18 via the first fasteners 20. Similarly, at the gearbox-facing end 30, the hub 34 attaches to gearbox-coupling member 22 via the second fasteners 26. The shaft-hub assembly 14 will be discussed further in the description.

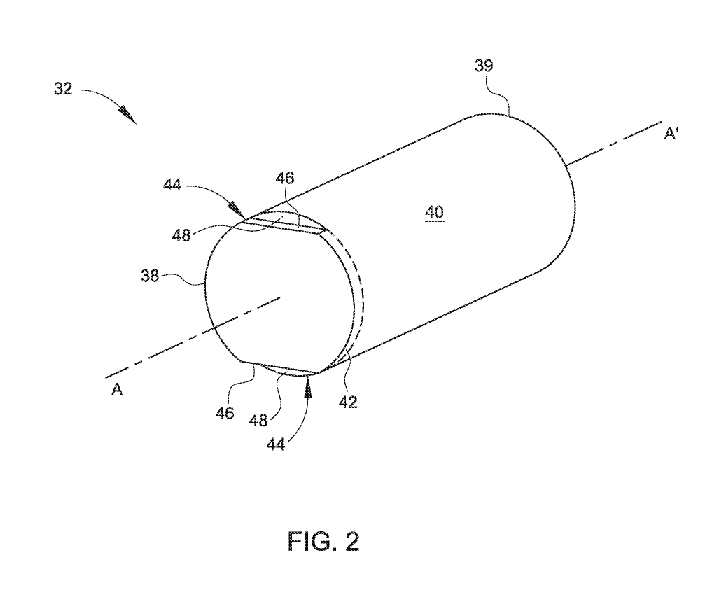

FIG. 2 shows the shaft 32 of the shaft-hub assembly 14. The shaft 32 includes a first end 38, a second end 39, and a cylindrical surface 40. The first end 38 and the second end 39 are defined along a central axis A-A′ of the shaft 32. The central axis A-A′ is parallel to a length of the shaft 32. The first end 38 is fixed to the hub 34 (refer to FIG. 1). The first end 38 may he connected to either of the motor-facing end 28 (refer to FIG. 1) or the gearbox-facing end 30 (refer to FIG. 1) of the shaft-hub assembly 14. The cylindrical surface 40 is defined between the first end 38 and the second end 39. A portion of the cylindrical surface 4C) adjoining the first end 38 defines a first surface 42. The first surface 42 includes a first slat 44 perpendicular to the central axis A-A′.

The first slot 44 includes a first face 46 and a second face 48. The first face 46 perpendicularly adjoins the second face 48. The first face 46 extends outward from the second face 48 in a plane perpendicular to the central axis A-A′. In the present embodiment, two first slots 44 are located diametrically opposite to each other on the first end 38. However, it is contemplated that the shaft 32 may include any number of first slats 44 and the shape and size of the first slot 44 may vary widely in a given application. For example, three of the first slots 44 may be positioned spaced apart from each other on the first end 38 of the shaft 32. Similarly, the shaft 32 may include a single first slot 44 on the first end 38 of the shaft 32.

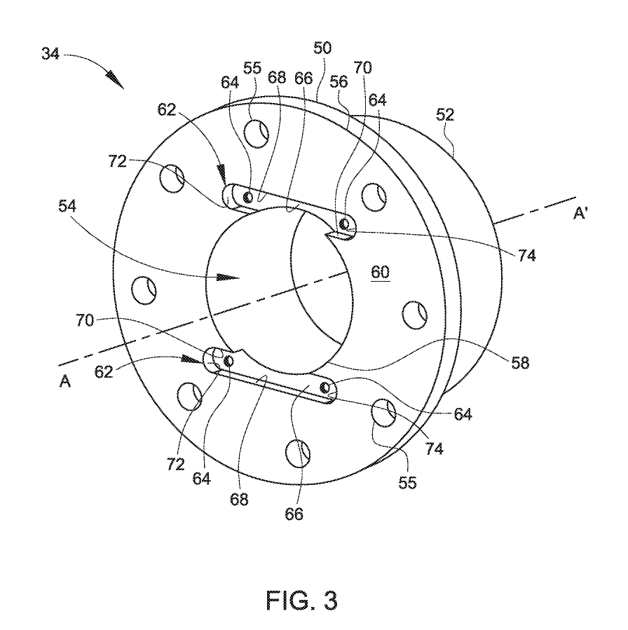

FIG. 3 shows the hub 34 of the shaft-hub assembly 14. The hub 34 includes a disc 50, a hollow cylindrical member 52, and an axial passage 54. The disc 50 adjoins the hollow cylindrical member 52 to define the axial passage 54 along the central axis A-A′. The axial passage 54 accommodates the shaft 32 (refer to FIG. 2) within the hub 34.

The disc 50 includes a number of hub-positioning holes 55, an outer surface 56, an inner surface 58, a front surface 60, a second slot 62, and a number of First holes 64. The hub-positioning holes 55 are circumferentially located on the disc 50. The hub-positioning holes 55 accommodate the first fasteners 20 to attach the hub 34 to the motor-coupling member 18 at the motor-facing end 28 of the shaft-hub assembly 14. Similarly, the hub-positioning holes 55 accommodate the second fasteners 26 to attach the hub 34 to the gearbox-coupling member 22 at the gearbox-facing end 30 of the shaft-hub assembly 14.

The hollow cylindrical member 52 adjoins the inner surface 58 of the disc 50 to define the axial passage 54. The axial passage 54 extends along the central axis A-A′. Length of the hollow cylindrical member 52 defines a length of the axial passage 54 in the hub 34.

The outer surface 56 and the inner surface 58 define the front surface 60. The second slot 62 is cut into the front surface 60 such that the second slot 62 is contained in a plane that is perpendicular to the central axis A-A′. The second slot 62 extends inwardly from the front surface 60. The second slot 62 is located at the inner surface 58 such that a portion of the disc 50 proximate to the inner surface 58 is cut to define a portion of the second slot 62.

The second slot 62 includes a support wall 66, a first sidewall 68, a second sidewall 70, and two lateral ends 72 and 74. The support wall 66 includes two first holes 64. The first holes 64 are threaded grooves that accommodate a number of key fasteners 76 (refer to FIG. 4). It is contemplated that number, shape, and location of the first holes 64 may vary in a given application.

The first sidewall 68, the second sidewall 70, and the lateral ends 72 and 74 extend inwardly from the front surface 60 towards the support wall 66. The first sidewall 68, the second sidewall 70, the lateral ends 72, and the support wall 66 form a cavity to house the key 36 (refer to FIG. 4). The first sidewall 68 is parallel to the second sidewall 70.

The lateral end 72 is located opposite to the lateral end 74 on the front surface 60. The lateral ends 72 and 74 are semi-circular in shape. It may he contemplated that the shape of the lateral ends 72 and 74 may vary corresponding to shape of the key 36 (refer to FIG. 4).

The support wall 66 and the second sidewall 70 adjoin the inner surface 58 of the disc 50. The support wall 66, the first sidewall 68, the second sidewall 70, and the lateral ends 72 and 74 define an elongate cavity of the second slot 62 for accommodating the key 36 (refer to FIG. 4). In the present embodiment, two second slots 62 are positioned diametrically opposite to each other on the front surface 60. However, it is contemplated that the hub 34 may include any number of second slots 62 and the second slot 62 may embody any shape and size, according to a given application. For example, three of the second slots 62 may be positioned spaced apart from each other on the front surface 60, such that each second slot 62 communicates with the axial passage 54 of the hub 34. Similarly, the hub 34 may include a single second slot 62 communicating with the axial passage 54 of the hub 34.

FIG. 4 shows an exploded view of the shaft-hub assembly 14 including the shaft 32 with two first slots 44, the hub 34 with two second slots 62, two keys 36, and four fasteners 76. The key 36 fits into the first slot 44 of the shaft 32 and the second slot 62 of the hub 34 in order to couple the shaft 32 to the hub 34. The key 36 includes a pair of first elongated sides 78, a pair of second elongated side 79, two transverse sides 80 and 82, and a number of second holes 84. The first elongated sides 78 perpendicularly adjoin the second elongated sides 79. The first elongated sides 78 and the second elongated sides 79 extend along a length of the key 36. The transverse sides 80 and 82 extend along a thickness of the key 36. The second holes 84 are located on the first elongated sides 78 such that the second holes 84 axially align with the first holes 64 of the hub 34. The second holes 84 are threaded grooves that accommodate the key fasteners 76. The key fasteners 76 are threaded screws that fasten the key 36 to the hub 34. In the present embodiment, two keys 36 are located diametrically opposite to each other in order to couple the shaft 32 to the hub 34. However, it is contemplated that the shaft-hub assembly 14 may include any number of the keys 36 and the key 36 may embody any shape and size for a given application. For example, three keys 36 may be secured in the three second slots 62 on the front surface 60, such that each key 36 interlocks the respective first slot 44 of the shaft 32 to the respective second slot 62 of the hub 34. Similarly, a single key 36 may interlock the single first slot 44 of the shaft 32 and the single second slot 62 of the hub 34.

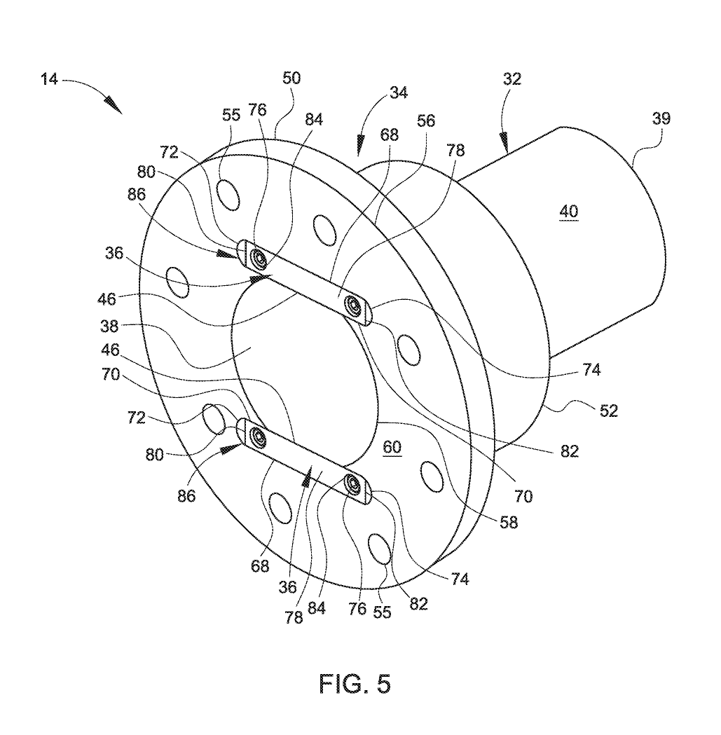

In the shaft-hub assembly 14, the axial passage 54 of the hub 34 accommodates the shaft 32. The first end 38 of the shaft 32 fits in the hub 34 such that the first surface 42 aligns with the inner surface 58. Upon coupling of the shaft 32 and the hub 34, the first face 46 of the first slot 44 of the shaft 32 aligns with the second sidewall 70 of the second slot 62 of the hub 34. Similarly, the second face 48 of the first slot 44 provided on the shaft 32 aligns with the support wall 66 of the second slot 62 provided on the hub 34. After alignment, a combination of the first slot 44 and the second slot 62 defines a key slot 86 (refer to FIG. 5) to accommodate the key 36. The key slot 86 (refer to FIG. 5) is perpendicular to the central axis A-A′.

The key 36 fits in the key slot 86 (refer to FIG. 5) in order to couple the shaft 32 to the hub 34. The first elongated sides 78 align with the support wall 66 and the second face 48. The second elongated sides 79 align with the first sidewall 68, the second sidewall 70, and the first face 46. The transverse sides 80 and 82 are positioned proximal to the lateral ends 72 and 74 respectively. The key fasteners 76 pass through the axially aligned second holes 84 and the first holes 64 to attach the key 36 to the disc 50.

FIG. 5 shows the shaft-hub assembly 14 in an assembled position. The shaft 32 is coupled to the hub 34 using an interference fit and the key 36. The key 36 is secured in the key slot 86 via the key fasteners 76. The key 36 tits in the key slot 86 and locks the first end 38 of the shaft 32 to the disc 50 in order to couple the shaft 32 to the hub 34.

### INDUSTRIAL APPLICABILITY

In operation, the motor 12 generates and transmits torque to the shaft-hub assembly 14. The shaft-hub assembly 14 includes the shaft 32 with the first slot 44 at the first end 38 and the hub 34 with the second slot 62 on the front surface 60. Upon coupling of the shaft 32 and the hub 34, the first slot 44 and the second slot 62 aligns to form the key slot 86 on the front surface 60 of the hub 34. The key 36 fits into the key slot 86 to couple the shaft 32 to the hub 34. The shaft 32 of the shaft-hub assembly 14 receives the torque via the hub 34 fixed at the motor-facing end 28. The shaft 32 further transmits torque to the hub 34 fixed at the gearbox-facing end 30. The key 36 transmits torque from the shaft 32 to the hub 34 at the motor-facing end 28 and from the hub 34 to shaft 32 at the gear-facing end. In addition, the key 36 prevents relative rotation between the shaft 32 and the hub 34.

The disclosed shaft-hub assembly 14 is characterized with the location of the key 36 at the first end 38 of the shaft 32, whereas in the existing shaft-hub assemblies, an axial key is fitted along the length of the shaft 32 in order to couple the shaft 32 to the hub 34. During rotation of the shaft-hub assembly 14, torsional stress develops throughout the shaft 32. The shaft 32 transfers a large portion of the developed torsional stress to the hub 34 by means of the interference fit between the shaft 32 and the hub 34. Thus, the torsional stress is maximum at the second end 39 of the shaft 32 and reduces to zero at the first end 38 of the shaft 32. Under torsional loading, a stress concentration occurs at the first slot 44 for the key 36 on the first end 38. However, absence of the torsional stress at the first end 38 of the shaft 32 results in a reduced effect of the stress concentration at the first end 38 of the shaft 32. Reduction in effect of the stress concentration in proximity of the key 36 improves performance, strength, and fatigue life of the shaft 32 under torsional loading.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

What is claimed is:

1. A shaft-hub assembly comprising:
a shaft including a first end and a second end, the first end and the second end defined along a central axis, the first end including a first surface, wherein the first surface includes a first slot provided perpendicular to the central axis;
a hub coupled to the shaft, the hub including a disc and a hollow cylindrical member, the disc being attached to the hollow cylindrical member thereby defining an axial passage along the central axis to accommodate the shaft, the disc including a second slot provided perpendicular to the central axis, wherein the disc includes a plurality of first holes provided in communication with the second slot; and
a key disposed within the first slot of the shaft and the second slot of the hub, the key including a plurality of second holes axially aligned with the plurality of first holes, wherein the key is secured to the hub via a plurality of key fasteners.
